(19) United States
(12) Patent Application Publication
(10) Pub. No.: US 2016/0180649 A1
(43) Pub. Date: Jun. 23, 2016

(54) GAMING SYSTEM WITH AUGMENTED WAGER POTENTIAL

(71) Applicant: Luke Squitiro, Palm Harbor, FL (US)

(72) Inventor: Luke Squitiro, Palm Harbor, FL (US)

(21) Appl. No.: 14/946,672

(22) Filed: Nov. 19, 2015

Related U.S. Application Data
(60) Provisional application No. 62/094,678, filed on Dec. 19, 2014.

(51) Int. Cl. G07F 17/32; A63F 1/00

(52) U.S. Cl. CPC G07F 17/3267; A63F 1/00; G07F 17/3293; G07F 17/3248; A63F 2001/003

(57) ABSTRACT

A method, apparatus, and computer readable storage to implement a gaming system which enables a player to augment an initial wager with an extra bet. In order to initiate the extra bet, the player must pay a vigorish along with the extra bet, the vigorish being determined based upon an actual game condition (such as the player's first card).

### BACKGROUND OF THE INVENTION

1. Field of the Invention

The present general inventive concept is directed to a method, apparatus, and computer readable storage medium directed to a casino gaming system which enables a player functionality to increase a previously made bet in the contemporaneous round.

2. Description of the Related Art

The casino game of blackjack is well known, for example see U.S. Patent publication 2003/0155715 which is incorporated by reference herein in its entirety.

FIG. 1 is a flowchart illustrating a method of implementing the known game of blackjack.

Points totals are computed by adding the standard rank value of each card, with face valued cards (tens, jacks, queens, kings) being given a value of 10, and aces being given a value of 1 or 11, whichever results in a better hand. A soft point total is where at least one ace is given the value of 11. A hard point total is a hand with all aces counting as 1.

In operation 100, the player makes a main wager by placing chips on a table. Then, in operation 102, the dealer deals two initial cards to each player (either face up or face down) and two initial cards to the dealer, typically one face down (“hole-card”), and one face up (the “up-card”). Then the player can decide whether to hit, stand, double, or split. If the player decides to hit, then the method proceeds to operation 106, which deals an additional card to a player. If a determination 108 determines that the player has busted (the player's hard point total is over 21), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by place an additional wager of up to the main wager, but the player is limited to drawing only one additional card before the player must stand.

If the player stands and has not busted out (either stands on his or her initial two cards or draws cards but has a point total under 22 and then stands), then the method proceeds to operation 112, which reveals all dealer's cards (e.g., turns the hole-card face up) and which then plays out the dealer's hand according to predetermined rules. In operation 114, if the dealer's total is greater than a predetermined amount (typically 17), then the dealer stands (proceeds to operation 122). If the dealer's total is not greater than the predetermined amount, the method proceeds to operation 116 which deals an additional card to the dealer. If it is then determined 118 that the dealer has not busted (has a point total over 21), the method returns to operation 114. If the dealer has busted, then the player wins the game and the main wager in operation 120 (this assumes the player has not also busted; if the player has already busted then the player would have lost in operation 110).

In operation 122, both the player and the dealer have played out their hand and neither have busted. Thus, their respective point totals (adding the numerical values of each card in the hand) are compared. If the dealer's point total is determined in operation 124 to be lower than the player's point total, then the player wins the game and the main wager in operation 120. Otherwise, if the dealer's point total is determined 128 to be greater than the player's point total, then the player loses the game and the main wager in operation 130. If the player's point total ties the dealer's point total, then that results in a “push” in operation 126 in which the player doesn't win or lose the main wager (the main wager bet is a wash).

If a player is initially dealt two identically ranked cards in operation 102, players can also split in operation 104 by placing an additional split wager equal in value to the main wager, and the player's two initial cards are separated and the dealer deals an additional card on each. The player then plays out each of the two separate hands, each from operation 104. Depending on house rules, players may or may not be allowed to resplit cards.

### SUMMARY OF THE INVENTION

It is an aspect of the present invention to provide an improved wagering system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing the known game of blackjack;

FIG. 2 is a flowchart illustrating an exemplary method of implementing an extra bet, according to an embodiment;

FIG. 3A is a drawing illustrating a gaming table, according to an embodiment;

FIG. 3B is a block diagram illustrating an electronic player tracking system associated with each gaming table, according to an embodiment;

FIG. 4A is a block diagram illustrating exemplary hardware that can be used to implement an electronic version of the methods described herein;

FIG. 4B is a block diagram illustrating an exemplary network configuration to implement a player playing an online version of the methods described herein;

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement an improved blackjack system, method, and computer readable storage medium. Embodiments of the inventive concept afford the player, after viewing only his first dealt card, on condition that the first dealt card is a 9, 10, jack, queen, or king, then the player has the option to make an extra bet of any amount before the player's second card is dealt (or any dealer's cards are dealt or exposed). When the player places the extra bet, the player also places vigorish (a commission or surcharge that the player pays directly to the house and is not part of the bet). Note that if the player's first card is a 9 rank (the suit doesn't matter), then the player would pay a 5% commission (vigorish). on top of his/her extra bet to make the extra bet, and if the player's first card is a 10, jack, queen, or king, then the player would pay a 20% commission (vigorish). If the player's first card is an ace through 8, then the player would not be permitted to make the extra bet. Of course the vigorish amounts and qualifying cards can change according to house preferences.

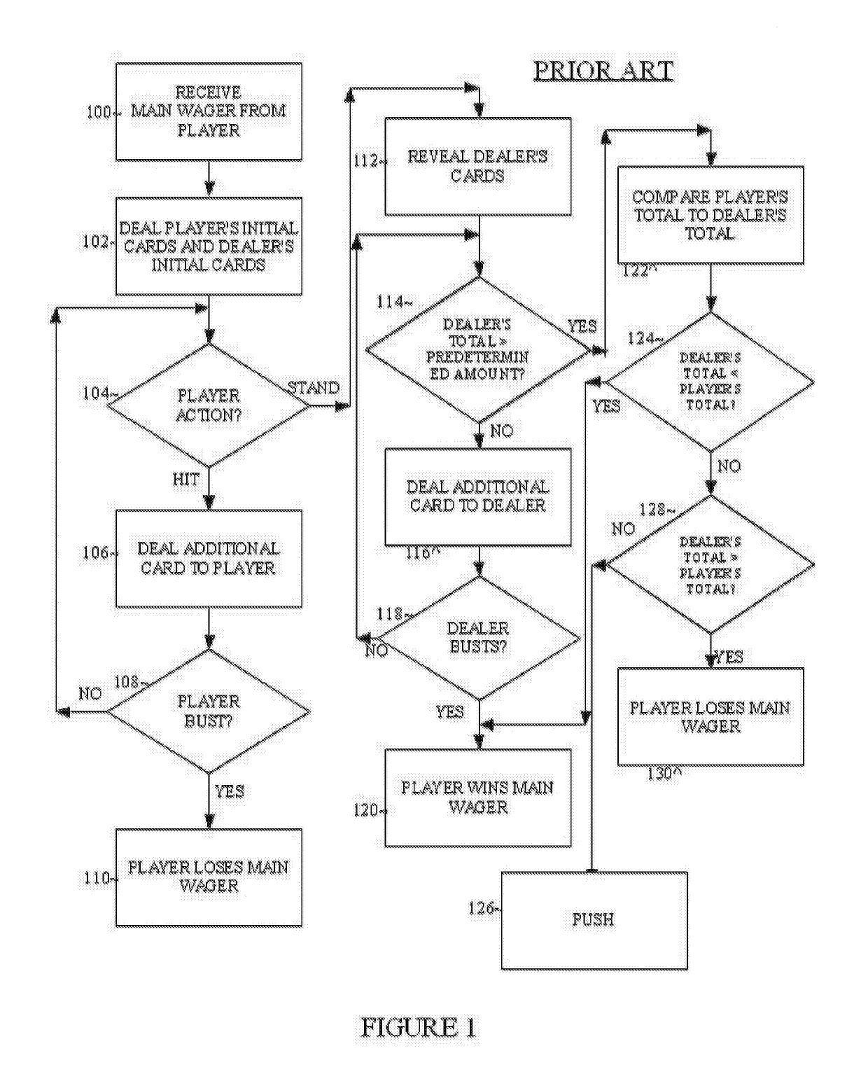

FIG. 1 is a flowchart illustrating a method of implementing the known game of blackjack.

In general, casino blackjack is played by one or more players at a gaming table against a dealer using one or more decks of cards (each deck can be a standard 52 card deck). The idea is for the player to make a point total closest to 21 without going over 21 (busting). Each player (after making a main wager) is dealt two initial cards (typically face up) and the dealer is also dealt two cards (one face up—the upcard, and one face down—the hole card). The player can stand on his or her initial two cards, or continuously hit (take another card) until the player stands or the player's point total is over 21 (upon which the player automatically loses). If the player has not busted, then after the player stands the dealer will play out the dealer's hand according to predetermined rules. One set of dealer predetermined rules is as follows: the dealer will continuously hit until the dealer's point total is greater than 16. Once the dealer has resolved the dealer's hand, the wager is resolved. If the player has busted then the player loses (the main wager). If the player has not busted but the dealer has busted (the dealer's point total is over 21) then the player wins (wins even money on the main wager). If both the player and the dealer have not busted, then if the player's point total is higher than the dealer's point total then the player wins (wins even money on the main wager). If both the player and the dealer have no busted, then if the dealer's point total is higher than the player's point total then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as 1 or 11 (whichever makes the best hand), 2's—10's count as their respective face value, jacks, queens, and kings all count as 10).

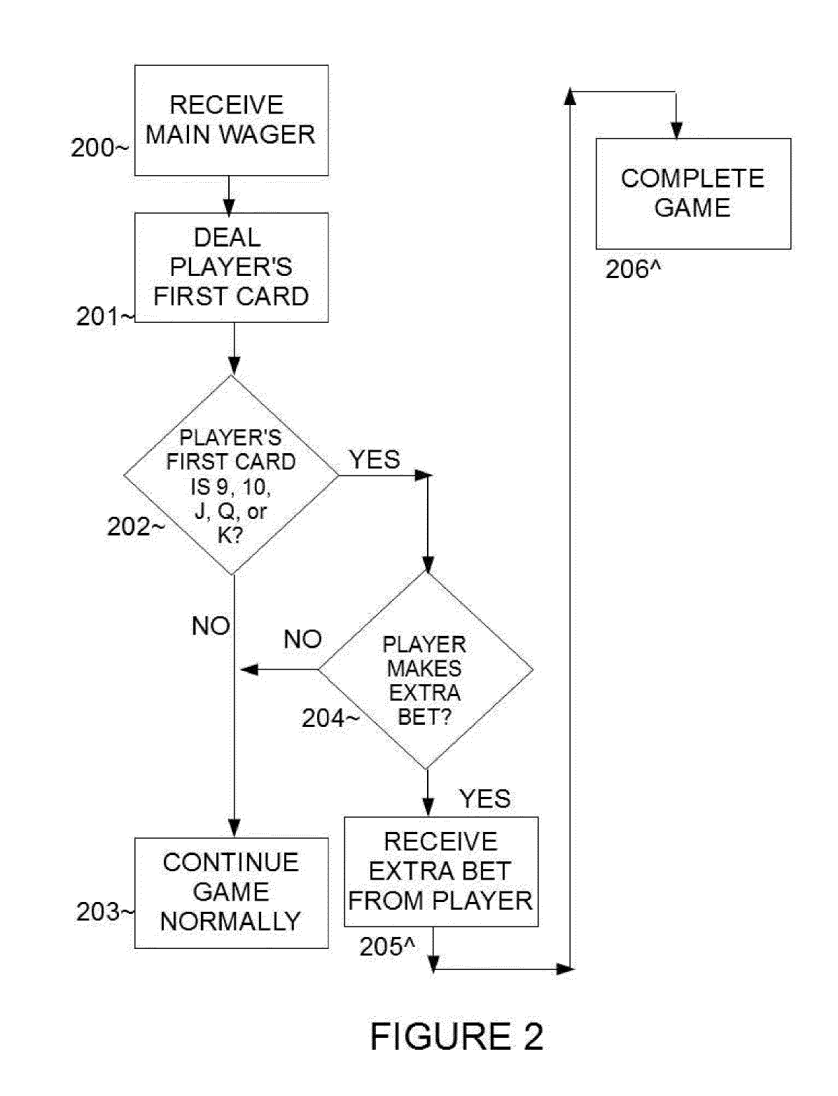

FIG. 2 is a flowchart illustrating an exemplary method of implementing an extra bet, according to an embodiment.

Operation 200 is performed the same as operation 100, which receives a main wager from a player. This is done by the player placing a wager (typically in the form of chips) in a respective betting circle on the felt layout.

From operation 200, the method proceeds to operation 201, which deals the player's first card only face up. No dealer cards are dealt at this time, or if any are dealt, none are revealed to anyone.

From operation 201, the method proceeds to operation 202, which determines whether the player's first card (dealt and revealed in operation 201) is in a predetermined set consisting of 9, 10, Jack, Queen, King. The suits do not matter, thus this set includes all suits of each included rank. Note that in different embodiments, the set can consist of different ranks.

If the player's first card is not in the predetermined set, then the method proceeds to operation 203 wherein the game continues normally. This means that the second player's card is dealt as well as the dealer's two cards (one up-card one hole card). The method then proceeds at operation 104 and continues like any standard blackjack game. No extra bet is made and the game proceeds normally.

If in operation 202 it is determined that the player's first card is in the predetermined set, then the method proceeds to operation 204, which determines whether the player makes the extra bet. The player can indicate their desire to make the extra bet by physical actions (such as making the extra bet) or in the electronic version by pressing a button which results in the extra bet being made. If the player does not make the extra bet, then the method proceeds to operation 203.

If in operation 204 the player makes the extra bet, then the method proceeds to operation 205 where the extra bet is actually received from the player. The player can make the extra bet in any amount the player chooses (up to a table limit which can be $5,000 or any other number). In another embodiment, the extra bet would be required to match the amount of (or be less than equal to) the initial wager.

In an embodiment, after the extra bet is added on top of the main wager, a lammer (marker) can be placed (by the dealer) on top of the chip stack (which comprises the main wager and the extra bet). Note that the vigorish is collected by the house and is not part of the chip stack. The lammer is a circular disk that is smaller than the diameter of a chip being used. The purpose of capping the chip stack with the lammer is for game protection purposes, so players cannot cheat by attempting to add chips on top of their chip stack after making the extra bet. This also verifies that the vigorish has been paid by the player.

Note that in addition to the extra bet, the player must pay a vigorish (house commission) to house (dealer) for the privilege of making the extra bet. If the player's initial card is a 9, then the player must pay the house (dealer) an additional 5% of the extra bet which the house (dealer) keeps under all circumstances. If the player's initial card is a 10, Jack, Queen, or King, then the player must pay the house (dealer) an additional 20% of the extra bet which the house (dealer) keeps under all circumstances. The extra bet is then added to the player's main wager and they are treated as a single wager (which is augmented from the main wager placed in operation 200). In other words, the “main wager” now becomes the main wager placed in operation 100 plus the extra bet.

From operation 205, the method proceeds to operation 206, which completes the game. This is done by continuing to operation 104 from FIG. 1. The game then completes normally, with the extra bet having been added to the player's main wager. Thus, if the player wins the game (operation 120) the player would win an even money payout on both the original main wager and the extra bet. If the player loses the game (operation 130) then the player loses both the original main wager and the extra bet. If the player pushes (operation 126) then the player pushes both the original main wager and the extra bet.

An example of the game will now be presented. Jack, Jill, and Bob are players at the same blackjack table. Jack makes a $10 main wager, Jill makes a $10 main wager, and Bob makes a $100 main wager. The dealer now deals Jack a first card of 5-spades, Jill a first card of 10-hearts, and Bob a first card of 9-clubs. The dealer now stops dealing (no other cards are dealt or revealed yet) and offers each player (whose first card is in the predetermined set) the chance to make the extra bet. Since Jack's first card (5-spades) is not the predetermined set then Jack cannot make the extra bet and Jack does nothing. Since Jill's first card (10-hearts) is in the predetermined set Jill decides to make an extra bet of $20. Jill also has to pay a 20% vigorish of the $20 which is $4. Thus, Jill puts up $24 in chips and the dealer takes the $4 as the vigorish and puts it in the dealer's chip rack. The $20 extra bet is now added to Jill's main wager of $10 for a total wager of $30. Bob also decides to make the extra bet and makes an extra bet of $100. Because Bob has a 9 as the first card, Bob has to put up a commission of 5% of the extra bet ($5). So Bob puts up $105 in chips, the dealer takes the $5 chip as commission and puts it in the chip rack and the $100 extra bet is added to the Bob's original $100 wager, giving Bob a $200 total wager amount. Now the game would continue as a normal game of blackjack (as illustrated in FIG. 1). Note that if players have the opportunity to double and split, they would do so normally with their new augmented wager being treated as any other wager. The dealer deals the dealer a hole-card, then deals Jack a queen-hearts (for a total of 15), deals Jill an ace (for a blackjack) and deals Bob a 2-spades (for a total of 11) and deals the dealer an up-card of 7-clubs. Jack decides to hit and is dealt a 9-spades which causes Jack to bust, and the dealer takes Jack's $10 main wager and Jack's game is over. Jill has a blackjack on her $30 total wager and is thus paid $45 (3:2 of her total wager) and Jill's game now ends (thus Jill can take $75 off the table as hers). Bob decides to double and makes a double wager of $200 and is dealt a 10-hearts (for a total of 21). The dealer reveals the dealer's hole card to be a ten-diamonds, thus giving the dealer a point total of 17 (hard). Thus the dealer stands and Bob wins (since Bob has a higher total than the dealer and Bob did not bust). Thus Bob wins a payout of $400 (even money on the total wager and even money on the double wager), thus Bob can now take the $800 in chips off the table and Bob's game ends.

In another embodiment, instead of paying the vigorish upon placing the bet, the vigorish can be taken out of any winnings from the extra bet. The extra bet is paid at even money and then the vigorish can be taken out of the winnings on the extra bet.

While the embodiments described herein cap the main wager with the extra bet (add the extra bet on top of the main wager), in another embodiment, the two bets can be kept separate (e.g., two separate piles inside the betting circle). This can be helpful in the previous embodiment where the vigorish is paid upon winning the extra bet so the amount of vigorish to be paid can be easily computed.

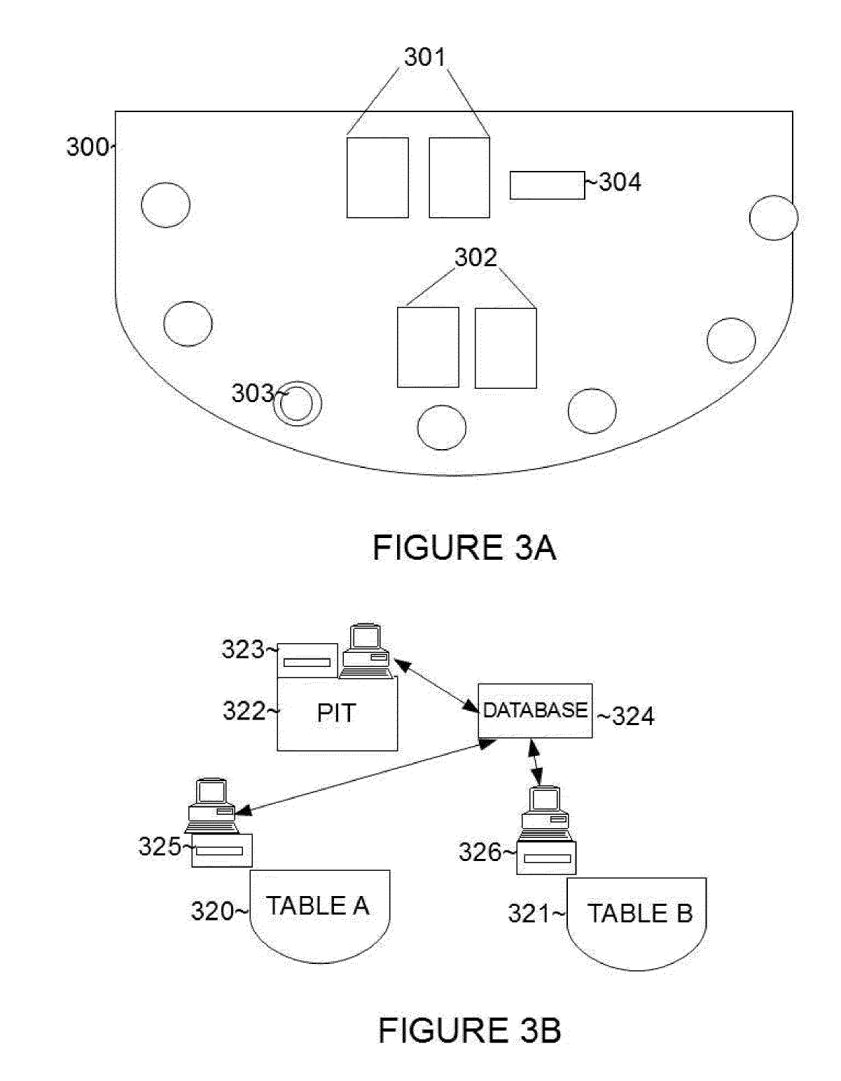

FIG. 3A is a drawing illustrating a gaming table, according to an embodiment.

A physical gaming table 300 (typically made of wood with felt on top with the layout imprinted on it) is used to play the game in a physical real world casino. One example of a table that can be used in a physical casino is illustrated in U.S. Design patent D263,975 which is incorporated by reference herein in its entirety. The layout on top of the felt has imprinted on it seven betting circles as illustrated in FIG. 3A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's hand 302 and a dealer's hand 301 are shown. A player's wager 303 is shown in the form of a chip or chips and is placed inside the player's betting circle. The dealer's area can also accommodate a physical card reader 304 for reading the dealer's hole card as described in U.S. Pat. No. 5,681,039, which is incorporated by reference in its entirety for all purposes. The physical card reader can be an electronic card reader which electronically scans a face down card and lights up a particular light (e.g., LED, etc.) if the face down card is a 10 or ace (which would give the dealer blackjack when the dealer's up-card is an ace or 10 respectively) otherwise a different light (e.g., a “green light”) lights up telling the dealer that the hole-card does not give the dealer blackjack and thus the dealer can continue dealing.

While not shown, the game can also be offered with any type of additional side bet in order to generate more action for the casino and more excitement for the players. Also not pictured in FIG. 3A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 3A is an optional shoe which the cards can be placed into and dealt out of by the dealer, such as the shoe described in U.S. Pat. No. 4,457,512 which is incorporated by reference herein in its entirety.

FIG. 3B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

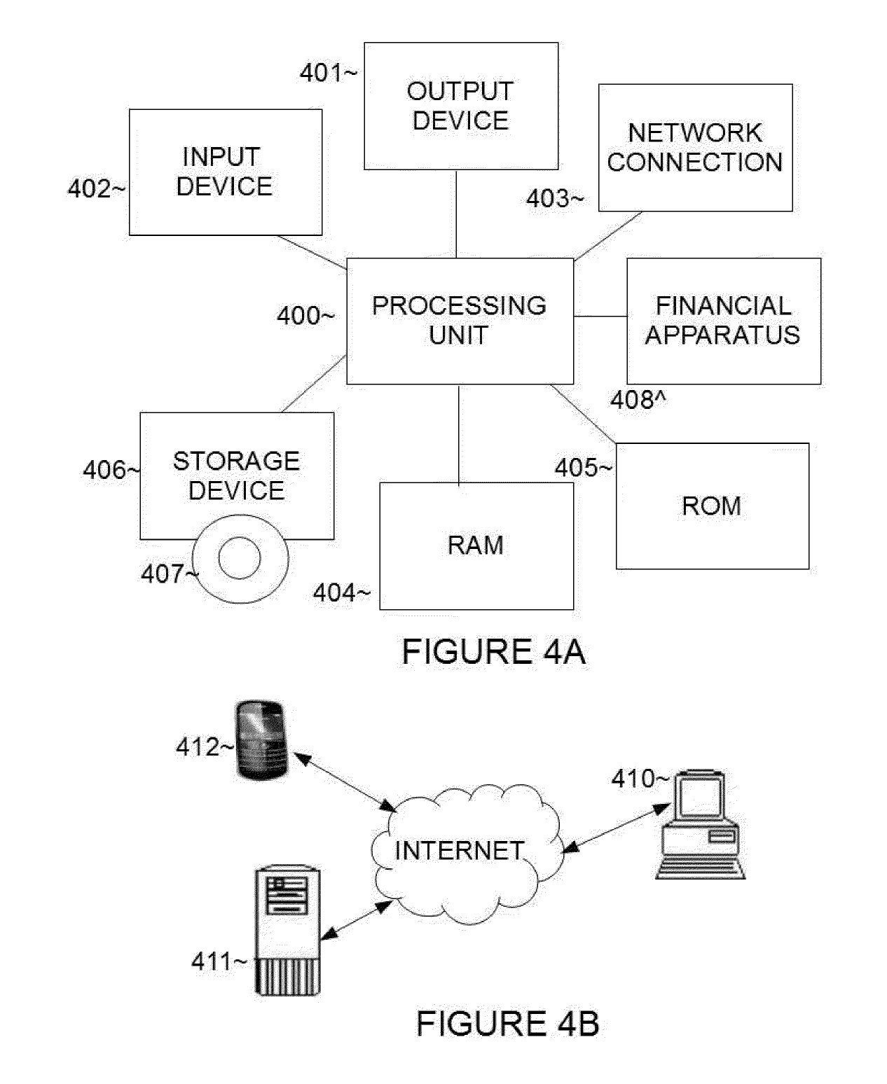

A gaming table A 320 (which can be used to play any method described herein) and a gaming table B 321 (which can be used to play any method described herein) can be associated with a pit 322 (which has its own computer) which has a card reader 323 to read the electronically encoded information on a player's card (the card reader can also be located at the tables themselves) and transmit the information to an associated computer which can communicate information contained on the player's card (e.g., an identification number of the player associated with the card) to the electronic database 324 along with play data relating to the player who owns the player's card. Table A 320 has its own card reader 325 and associated computer (the one next to card reader 325 which receives information from the card reader 325) and table B 321 also has its own card reader 326 and associated computer (the one next to card reader 326 which receives information from the card reader 326). The computers at table A 320 and table B 321 are connected to the electronic database 324. Casino employees can enter data regarding each player's play (for those players that present a players card) into a computer at the table or at the pit which transmits the play data (e.g., average bet amount, time of play, etc.) to the electronic casino database 324 that stores playing history information for players at the casino. The computers illustrated in FIG. 3B can all have the structure as illustrated in FIG. 4A.

FIG. 4A is a block diagram illustrating hardware that can be used to implement electronic versions of all methods and features described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 400 (such as one or more microprocessor and any associated components) is connected to an output device 401 (such as an LCD monitor, touch screen, CRT, etc.) which is used to display to the player any aspect of the method, and an input device 402 (e.g., buttons, a touch screen, a keyboard, mouse, etc.) which can be used to input from the player any decision made by the player. All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, etc. Multiple such processing units can also work in collaboration with each other (in a same or different physical location). A non-transitory computer readable storage medium 407 can store a program which can control the electronic device to perform any of the methods described herein and can be read by the storage device 406. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 4B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 410 (e.g., cell phone, tablet, PC, etc.) can connect to a server 411 (which can have the structure illustrated in FIG. 4A) using a computer communications network such as the Internet. The server 411 hosts an online casino which determines the outcomes of the game and serves the outcomes to the computer 410 so the computer 410 displays the outcomes to the player. Other users can also play at the online casino hosted by the server 411 simultaneously, such as using a cell phone 412 with wireless internet connectivity. Any number of players connected to the internet can play contemporaneously at the sever 411. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

The word “deal” as used herein can mean two things: a) physically deal a card from a deck (real or virtual) face up or face down; b) reveal (turn face up a face down card) which was previously dealt. Thus, “dealing” includes taking a card from the shoe (if one is being used) and putting it on the table (face up or face down), or taking a card from the shoe (if one is being used) and putting it face down on the table and then (at a later point in time) turning it face up. Thus, if a three card hand is dealt two cards face up and one card face down (which is turned face up later), or a three card hand is dealt two cards face up and at a later time the third card is dealt face up, these are equivalent and both fall under the word “deal.” Note that the words “bet” and “wager” are used synonymously herein.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a blackjack game, the method comprising:
receiving a main wager from a player in the form of chips;
dealing a first card to the player using at least one physical deck of cards;
determining that the first card is in a predetermined set of cards;
offering the player to place an extra bet;
receiving the extra bet from the player;
collecting from the player a vigorish from the player being a percentage amount of the extra bet;
adding the extra bet to the main wager;
completing the blackjack game using the at least one physical deck of cards and resolving the main wager which also now comprises the extra bet based on an outcome of the game.

2. The method as recited in claim 1, wherein the predetermined set of cards consists of nines, tens, jacks, queens, and kings.

3. The method as recited in claim 1, wherein the percentage amount is 5% when the first card is a nine

4. The method as recited in claim 1, wherein the percentage amount is 20% when the first card is a ten-valued card.

5. The method as recited in claim 3, wherein the percentage amount is 20% when the first card is a ten-valued card.

6. The method as recited in claim 2, wherein the percentage amount is 20% when the first card is a ten-valued card.

7. The method as recited in claim 6, wherein the percentage amount is 20% when the first card is a ten-valued card.

8. A method, comprising:
providing an electronic input unit, an electronic output unit, and at least one electronic processing unit operationally connected to the electronic input unit and the electronic output unit;
performing, on the at least one electronic processing unit, the following operations:
receiving a main wager from a player;
dealing a first card to the player using at least one virtual deck of cards;
determining that the first card is in a predetermined set of cards;
offering the player to place an extra bet;
receiving the extra bet from the player;
collecting from the player a vigorish from the player being a percentage amount of the extra bet;
adding the extra bet to the main wager;
completing the blackjack game using the at least one virtual deck of cards and resolving the main wager which also now comprises the extra bet based on an outcome of the game.

9. The method as recited in claim 8, wherein the predetermined set of cards consists of nines, tens, jacks, queens, and kings.

10. The method as recited in claim 8, wherein the percentage amount is 5% when the first card is a nine

11. The method as recited in claim 8, wherein the percentage amount is 20% when the first card is a ten-valued card.

12. The method as recited in claim 10, wherein the percentage amount is 20% when the first card is a ten-valued card.

13. The method as recited in claim 9, wherein the percentage amount is 20% when the first card is a ten-valued card.

14. The method as recited in claim 13, wherein the percentage amount is 20% when the first card is a ten-valued card.

15. An apparatus, comprising:
an electronic input unit and an electronic output unit;
an electronic processing unit connected to the electronic input unit and the electronic output unit, the electronic processing unit configured to execute computer readable instructions which are programmed to, when executed, cause the electronic processing unit to:
receive a main wager from a player;
deal a first card to the player using at least one virtual deck of cards;
determine whether the first card is in a predetermined set of cards;
when the first card is in the predetermined set of cards, then
a) enable the player to make the extra bet;
b) when the player makes the extra bet, collect a vigorish from the player which is a percentage amount of the extra bet and add the extra bet to the main wager;
complete the blackjack game using the at least one virtual deck of cards; and
resolve the main wager based on an outcome of the game.

16. The apparatus as recited in claim 15, wherein the computer readable instructions are further programmed such that the predetermined set of cards consists of nines, tens, jacks, queens, and kings.

17. The apparatus as recited in claim 15, wherein the computer readable instructions are further programmed such that the percentage amount is 5% when the first card is a nine

18. The apparatus as recited in claim 15, wherein the computer readable instructions are further programmed such that the percentage amount is 20% when the first card is a ten-valued card.
